(19) United States
(12) Patent Application Publication
(10) Pub. No.: US 2014/0004737 A1
(43) Pub. Date: Jan. 2, 2014

(54) BATTERY HOLDER

(71) Applicant: Chou Hsien TSAI, Taipei Hsien (TW)

(72) Inventor: Chou Hsien TSAI, Taipei Hsien (TW)

(21) Appl. No.: 13/931,901

(22) Filed: Jun. 29, 2013

(30) Foreign Application Priority Data
Jul. 1, 2012 (TW) 101212711
Feb. 25, 2013 (TW) 102203559
Apr. 18, 2013 (CN) 201320197776.8

(51) Int. Cl. H01M 2/10

(52) U.S. Cl. CPC H01M 2/10
USPC 439/500

(57) ABSTRACT

A battery holder includes: a plastic base having at least one positive terminal fixing slot, a negative terminal fixing slot and an accommodating slot, the accommodating slot having a bottom portion and a circumferential wall; at least one positive terminal integrally having a fixing portion, an elastic arm and at least one pin; and a negative terminal integrally having a fixing portion, an elastic arm and at least one pin. The positive terminal fixing slot is disposed on the bottom portion, extends horizontally and has an inserting port on one end of the bottom portion. The horizontal fixing portion of the positive terminal is inserted into and engages with the positive terminal fixing slot through the inserting port. A circumferential wall above the inserting port has an opening, through which the contact of the positive terminal can run to the accommodating slot.

### BACKGROUND OF THE INVENTION

1. Field of the Invention

The invention relates to an electrical connector, and more particularly to a battery holder.

2. Related Art

Positive and negative terminals of a conventional battery holder are assembled with and fixed to a plastic base in a vertical direction. Because the bottom thickness of the plastic base is limited, the fixing slots of the positive and negative terminals have the fixed lengths that are not long, and cannot strongly fix the positive and negative terminals. In addition, the plastic base has the substantially circular shape and the larger width so that the material is wasted. When there are many plastic bases to be connected and assembled together, the number of wider plastic bases to be connected and assembled together at a time decreases, and the material for terminal pressing is further wasted due to the large gap.

### SUMMARY OF THE INVENTION

A main object of the invention is to provide a battery holder, in which the terminal has the better fixing effect due to horizontal terminal fixing slots.

Another object of the invention is to provide a battery holder, wherein the assembling convenience is achieved by forming a plateless cut surface on a horizontal fixing portion of each of positive and negative terminals.

Still another object of the invention is to provide a battery holder, in which positive and negative terminals are formed by pressing the same metal sheet and then one-time assembled into positive and negative terminal slots on the same end of the plastic base, thereby simplifying the manufacturing processes.

The invention provides a battery holder including a plastic base, at least one positive terminal and a negative terminal. The plastic base has at least one positive terminal fixing slot, a negative terminal fixing slot and an accommodating slot. The accommodating slot has a bottom portion and a circumferential wall. The circumferential wall is disposed around the bottom portion. A top surface of the bottom portion is a receiving surface for receiving a negative surface of a battery. The at least one positive terminal integrally has a fixing portion, an elastic arm and at least one pin. The fixing portion is fixed to the positive terminal fixing slot. The elastic arm is connected to the fixing portion, extends upward and has a contact laterally projecting toward the accommodating slot, and the pin is connected to the fixing portion and extends out of the plastic base. The negative terminal integrally has a fixing portion, an elastic arm and at least one pin. The fixing portion is fixed to the negative terminal fixing slot, the elastic arm is connected to the fixing portion, is elastically vertically movable and has a contact projecting upwardly toward the accommodating slot, and the pin is connected to the fixing portion and extends out of the plastic base. The positive terminal fixing slot is disposed on the bottom portion, extends horizontally and has an inserting port located at one end of the bottom portion. The fixing portion of the positive terminal is horizontal and inserted from the inserting port and engages with the positive terminal fixing slot. The circumferential wall above the inserting port has an opening so that the contact of the positive terminal can run to the accommodating slot through the opening.

The invention also provides a battery holder including a plastic base, at least one positive terminal and a negative terminal. The plastic base has at least one positive terminal fixing slot, a negative terminal fixing slot and an accommodating slot. The accommodating slot has a bottom portion, a receiving surface and a circumferential wall. The circumferential wall is connected to left and right sides of the bottom portion and extends upward. The receiving surface is connected to a rear end of the circumferential wall and extends vertically so that the accommodating slot is vertical. The receiving surface is for receiving a negative surface of a battery. A top end of the circumferential wall has a notch into which the finger can be inserted to take the battery. The at least one positive terminal integrally has a fixing portion, at least one elastic arm and at least one pin. The fixing portion is fixed to the positive terminal fixing slot. The elastic arm is connected to the fixing portion, is elastically movable and has a contact projecting toward the accommodating slot. The pin is connected to the fixing portion and extends out of the plastic base. The negative terminal integrally has a fixing portion, an elastic arm and at least one pin. The fixing portion is fixed to the negative terminal fixing slot. The elastic arm is elastically movable in a front-to-rear direction and has a contact projecting beyond the receiving surface toward the accommodating slot. The pin is connected to the fixing portion and extends out of the plastic base. At least one of the positive and negative terminal fixing slots is disposed on the bottom portion, extends horizontally and has an inserting port located at one end of the bottom portion. At least one of the fixing portions of the positive and negative terminals is horizontal and is inserted from the inserting port and engages with the positive and negative terminal fixing slots.

With the above-mentioned structure, the invention can achieve the objects of fixing the terminals and simplifying the manufacturing processes.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a pictorially assembled view showing a first embodiment of the invention.

FIG. 2 is a side cross-sectional assembled view showing the first embodiment of the invention.

FIG. 3 is a pictorially exploded view showing the battery holders connected and assembled together according to the first embodiment of the invention.

FIG. 4 is a pictorially exploded view showing a second embodiment of the invention.

FIG. 4A is a pictorially cross-sectional view showing a plastic base according to the second embodiment of the invention.

FIG. 5 is a pictorially assembled view showing the second embodiment of the invention.

FIG. 6 is a pictorially assembled view showing the second embodiment of the invention.

FIG. 7 is a side cross-sectional assembled view showing the second embodiment of the invention.

FIG. 8 is a pictorially exploded view showing a third embodiment of the invention.

FIG. 9 is a pictorially assembled view showing the third embodiment of the invention.

FIG. 10 is a side cross-sectional assembled view showing the third embodiment of the invention.

FIG. 11 is a pictorially exploded view showing a fourth embodiment of the invention.

FIG. 11A is a pictorial view showing a plastic base according to the fourth embodiment of the invention.

FIG. 12 is a pictorially assembled view showing the fourth embodiment of the invention.

FIG. 13 is an assembled front view showing the fourth embodiment of the invention.

FIG. 14 is an assembled rear view showing the fourth embodiment of the invention.

FIG. 15 is a cross-sectional side view showing a used state according to the fourth embodiment of the invention.

FIG. 16 is a cross-sectional side view showing the used state according to the fourth embodiment of the invention.

FIG. 17 is a cross-sectional side view showing a fifth embodiment of the invention.

FIG. 18 is a pictorially exploded view showing a sixth embodiment of the invention.

FIG. 19 is a pictorially exploded view showing a seventh embodiment of the invention.

FIG. 20 is a pictorially exploded view showing an eighth embodiment of the invention.

FIG. 21 is a pictorially assembled view showing the eighth embodiment of the invention.

FIG. 22 is an assembled rear view showing the eighth embodiment of the invention.

FIG. 23 is a cross-sectional side view showing a used state according to the eighth embodiment of the invention.

FIG. 24 is a cross-sectional side view showing a used state according to a ninth embodiment of the invention.

FIG. 25 is a front view showing the used state according to the ninth embodiment of the invention.

FIG. 26 is a pictorially exploded view showing a tenth embodiment of the invention.

FIG. 27 is a pictorially assembled view showing the tenth embodiment of the invention.

FIG. 28 is another pictorially assembled view according to the tenth embodiment of the invention.

FIG. 29 is a pictorially exploded view showing an eleventh embodiment of the invention.

FIG. 30 is a pictorially exploded view showing a twelfth embodiment of the invention.

FIG. 31 is a cross-sectional side view showing a used state according to a thirteenth embodiment of the invention.

FIG. 32 is a pictorial view showing a positive terminal according to the thirteenth embodiment of the invention.

FIG. 33 is a cross-sectional side view showing the used state according to the thirteenth embodiment of the invention.

FIG. 34 is a pictorial view showing a positive terminal according to a fourteenth embodiment of the invention.

FIG. 35 is a pictorially exploded view showing a fifteenth embodiment of the invention.

### DETAILED DESCRIPTION OF THE INVENTION

The present invention will be apparent from the following detailed description, which proceeds with reference to the accompanying drawings, wherein the same references relate to the same elements.

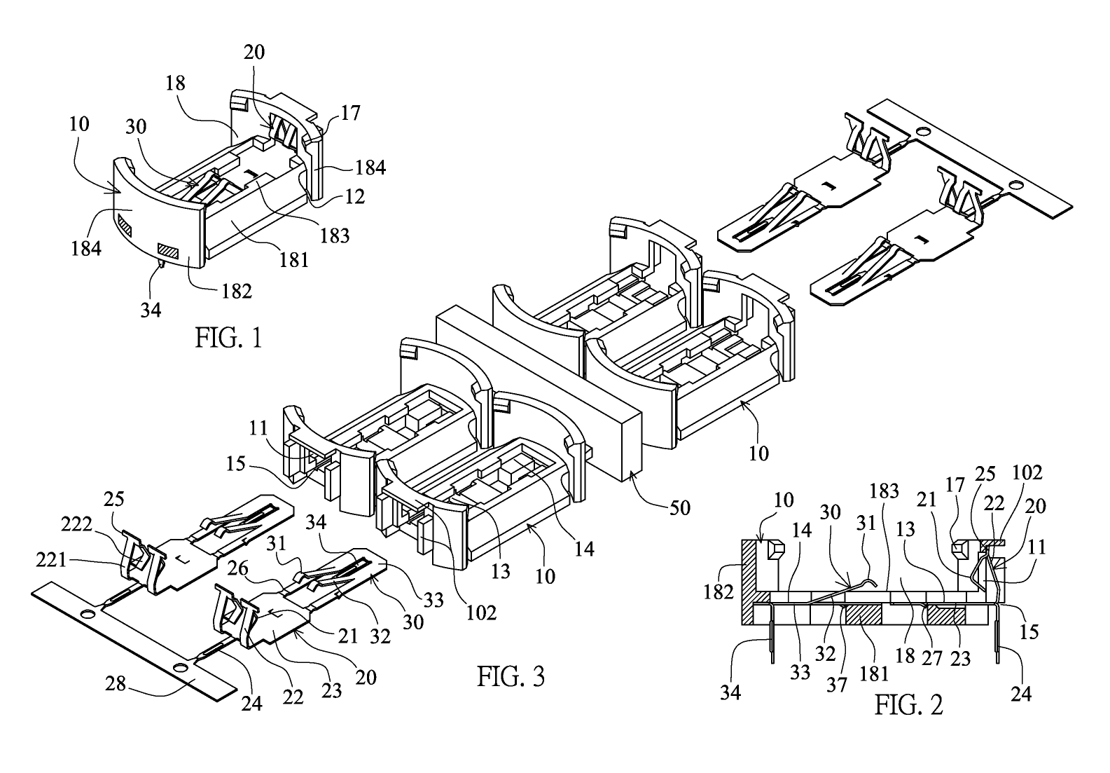

Referring to FIGS. 1 to 3, a horizontal battery holder according to the first embodiment of the invention includes a plastic base 10, a positive terminal 20 and a negative terminal 30.

The plastic base 10 has an accommodating slot 18, a positive terminal fixing slot 13 and a negative terminal fixing slot 14. The accommodating slot 18 has a bottom portion 181 and a circumferential wall 182 surrounding the bottom portion 181. A top surface of the bottom portion 181 is a receiving surface 183 for receiving a negative surface of a battery. The positive and negative terminal fixing slots 13 and 14 are disposed on the bottom portion 181, extend in the same horizontal direction, and have the same inserting port 15. The positive terminal fixing slot 13 is closer to the inserting port 15. The positive terminal fixing slot 13 is wider than the negative terminal fixing slot 14. The circumferential wall above the inserting port 15 has an opening 11. Two sides of the plastic base 10 are cut off to decrease the width so that the bottom portion 181 is a longitudinal body and the circumferential wall 182 is in the form of two opposite walls 184. The two opposite walls 184 are connected to two opposite ends of the bottom portion 181. The top ends of the two opposite walls 184 are closed and have no notch. Each of inner edges of the two opposite walls 184 has two projecting engaging blocks 17 engaging with two sides of the positive surface of the battery. Top and bottom ends of each engaging block 17 have inclined guiding surfaces for guiding the battery in and out. The lower edge of the circumferential wall corresponding to the four engaging blocks 17 is separated from the bottom portion 181 by a gap 12 and to be staggered with the projecting position of the engaging block 17.

In addition, the circumferential walls disposed above and on two sides of the inserting port of the positive terminal fixing slot 13 have flanges 102 for shielding the top side and two sides of the positive terminal 20. The width of the inserting port 15 is larger than the widths of the fixing portions 23 and 33 of the positive and negative terminals 20 and 30 or the widths of inserting ends of the fixing portions 23 and 33.

The plastic base 10 is formed by way of plastic injection molding and by combining top and bottom molds without using a slider. That is, the plastic base 10 has no opposite top and bottom surfaces.

The plate surface of the positive terminal 20 is bent to form a fixing portion 23, an elastic arm 22 and a pin 24. The fixing portion 23 is horizontally fixed to the positive terminal fixing slot 13. The plate surface of the fixing portion 23 is prodded to form a projecting inverse hook 27 capable of engaging with the bottom portion 181 of the plastic base 10. The plate surface of the elastic arm 22 is pressed to form two force arms. Each force arm has a first force arm 221 and a second force arm 222. The first force arm 221 is connected to the fixing portion 23 and extends upward. The second force arm 222 is connected to the first force arm 221 and extends downwards to form a contact 21 laterally projecting toward the accommodating slot 18. Each of the top ends of the two first force arms 221 has an externally projecting engaging portion 25 resting against and outside the circumferential wall 182. The contact 21 extends into the accommodating slot 18 from the opening 11 so as to prevent the laterally elastically movable positive terminal 20 from kneeling down when being forced. The pin 24 is formed by pressing and bending the plate surface of the elastic arm 22. The pin 24 is vertically connected to the fixing portion 23 and has an end section vertically extending out of the plastic base.

The plate surface of the negative terminal 30 is bent to form a contact 31, an elastic arm 32, a fixing portion 33 and a pin 34. The fixing portion 33 is horizontally fixed to the negative terminal fixing slot 14. The fixing portion 23 of the positive terminal is wider than the fixing portion 33 of the negative terminal. The plate surfaces of two sides of the fixing portion 33 are prodded to form a projecting inverse hook 37 for engaging with the bottom portion 181 of the plastic base 10. The elastic arm 32 is connected to the fixing portion 33 and inclined upwards. The elastic arm 32 is elastically vertically movable and has the contact 31, which is close to the distal end thereof and projects beyond the receiving surface 183. The pin 34 is prodded and bent downwards from the plate surface of the fixing portion 33, and has the end section vertical extending out of the plastic base.

This embodiment is manufactured by way of connecting and assembling together. That is, multiple plastic bases 10 are connected together by an equally-spaced connection structure 50. The pairs of positive and negative terminals 20 and 30 are integrally formed by pressing the same metal sheet. The pin 24 of each positive terminal 20 is connected to a material tape 28. The fixing portions of each pair of positive and negative terminals are connected together through a connection sheet 26.

Upon assembling, multiple pairs of positive and negative terminals 20 and 30 are assembled with multiple plastic bases 10, connected together, at a time. The fixing portions 23 and 33 of each pair of positive and negative terminals 20 and 30 are assembled into and engaged with the positive and negative terminal fixing slots 13 and 14 from the same inserting port 15. The contacts 21 and 31 of the positive and negative terminals extend to the accommodating slot 18 through the opening 11.

After each pair of positive and negative terminals 20 and 30 and one plastic base 10 are assembled and positioned, the pins 24 and 34 of the positive and negative terminals 20 and 30 are bent, and the connection sheet 26, the material tape 28 and the equally-spaced connection structure 50 are broken.

According to the above-mentioned structure and manufacturing method, two sides of the plastic base 10 are cut off to decrease the width so that the structure is simplified, the integral plastic injection can be easily performed, and the terminals can be easily assembled. The horizontal terminal fixing slots can provide the better fixing effects for the terminals, and the positive and negative terminals can be assembled at a time so that the assembling processes can be performed more quickly.

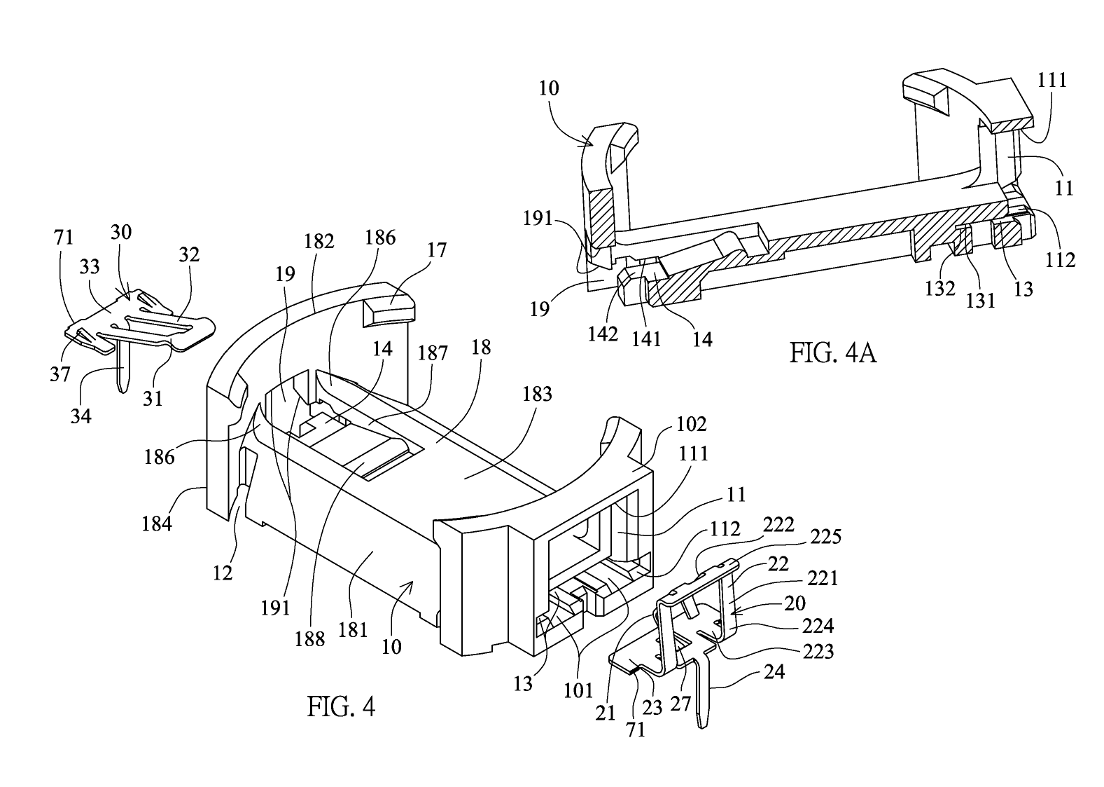

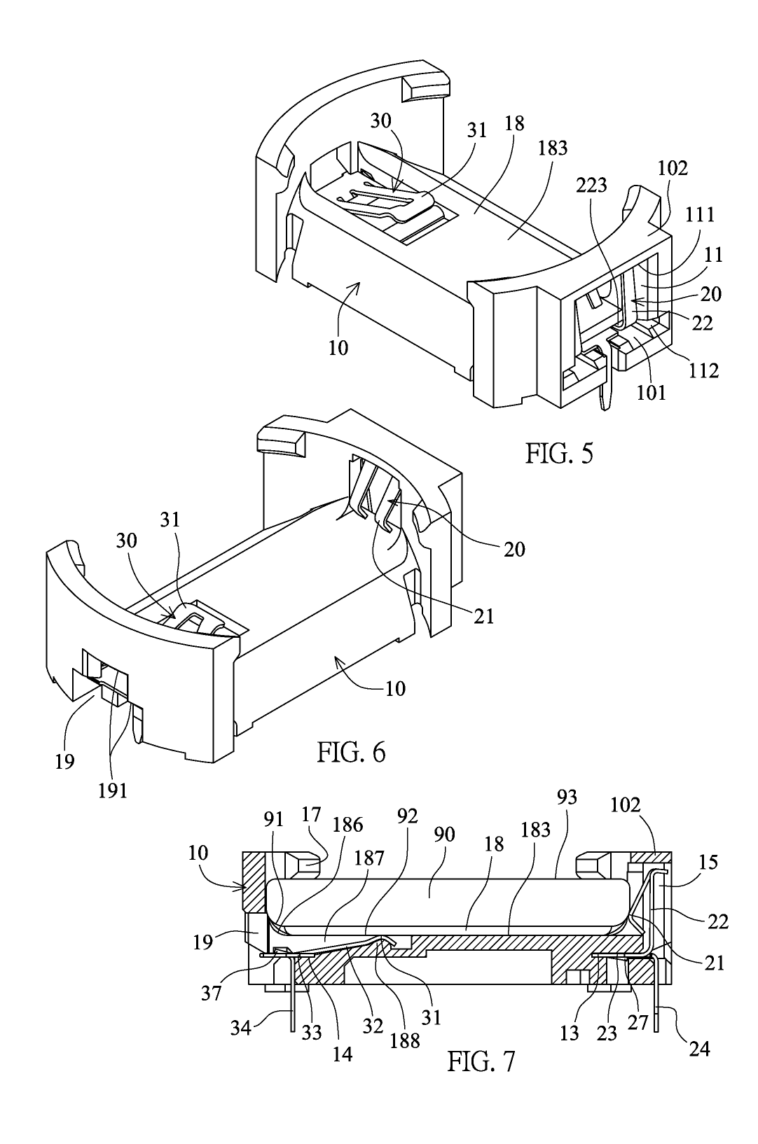

As shown in FIGS. 4 to 7, the second embodiment of the invention is substantially the same as the first embodiment except for the following differences. The positive and negative terminal fixing slots 13 and 14 are horizontal and mutually reversely extend to have the individual inserting ports. The fixing portion 23 of the positive terminal 20 is horizontally and correspondingly assembled into the positive terminal fixing slot 13. The circumferential wall above the inserting port has an opening 11, through which the contact 21 of the positive terminal 20 can pass. The first force arm 221 of the positive terminal has a horizontal force arm 223 and a vertical force arm 224 and has the better elasticity. The vertical force arm 224 rests against the circumferential walls on two sides of the opening 11. At least portions of the top surface 111 and the bottom surface 112 of the opening 11 are aligned with each other vertically. That is, the top surface and the bottom surface facing each other are provided. At least portions of the top surface 131 and the bottom surface 132 of the positive terminal fixing slot 13 are aligned with each other vertically. That is, the top surface and the bottom surface facing each other are provided. Each of two sides of the bottom surface 112 has a slot 101 providing an elastic moving space for the horizontal force arm 223 of the positive terminal 20. The fixing portion 33 of the negative terminal 30 is horizontally and correspondingly assembled into the negative terminal fixing slot 14. The circumferential wall above the inserting port of the negative terminal fixing slot 14 has an opening 19, through which the contact 31 of the negative terminal 30 can pass. The opening 19 only has a top surface 191 but has no bottom surface. The top surface 141 and the bottom surface 142 of the negative terminal fixing slot 14 are vertically staggered. That is, the top surface 141 and the bottom surface 142 do not face each other.

In addition, each of two sides of the outer end (connected to the other end of the pin 24) of the fixing portion 23 of the positive terminal 20 has a plateless cut surface 71. Each of two sides of the outer end (connected to one end of the pin 34) of the fixing portion 33 of the negative terminal 30 has a plateless cut surface 71. The pins 24 and 34 of the positive and negative terminals 20 and 30 are formed by pressing and bending the plate surface of the elastic arm.

With the above-mentioned structure, the peripheries of the positive terminal fixing slot 13 and the opening 11 may have the better structural strength. Because the opening 11 is larger, the plastic structural strength of this portion needs to be considered. In order to reinforce the structural strength, a slider has to be used when the positive terminal fixing slot 13 and the opening 11 are formed by way of plastic injection molding and by combining the top and bottom molds, so that the top and bottom surfaces facing each other are formed. Because the opening 19 is smaller, no slider needs to be used when the negative terminal fixing slot 14 and the opening 19 are formed by way of plastic injection molding and by combining the top and bottom molds. The plastic base 10 has the optimum design satisfying both the structural strength and the convenience in manufacturing.

Referring to FIG. 7, the receiving surface 183 has a slot 187. The bottom surface of the slot 187 has a flange 188 resting against the elastic arm 32 of the negative terminal. A circular arc surface 186 is formed between the circumferential wall 182 and the receiving surface 183. The lower periphery of the battery 90 has a circular arc 91 corresponding to the circular arc surface 186. The area of the negative surface 92 of the battery 90 is smaller than that of the positive surface 93. The area of the receiving surface 183 is disposed substantially in correspondence with the area of the negative surface 92 of the battery 90. However, the area of the positive surface 93 is larger than the area of the receiving surface 183. So, the positive surface 93 of the battery 90 cannot be easily placed on the receiving surface 183. With the above-mentioned structure, the combined structural strength between the circumferential wall 182 and the bottom portion 181 can be enhanced. In addition, when the battery 90 is placed reversely, the user can immediately know that.

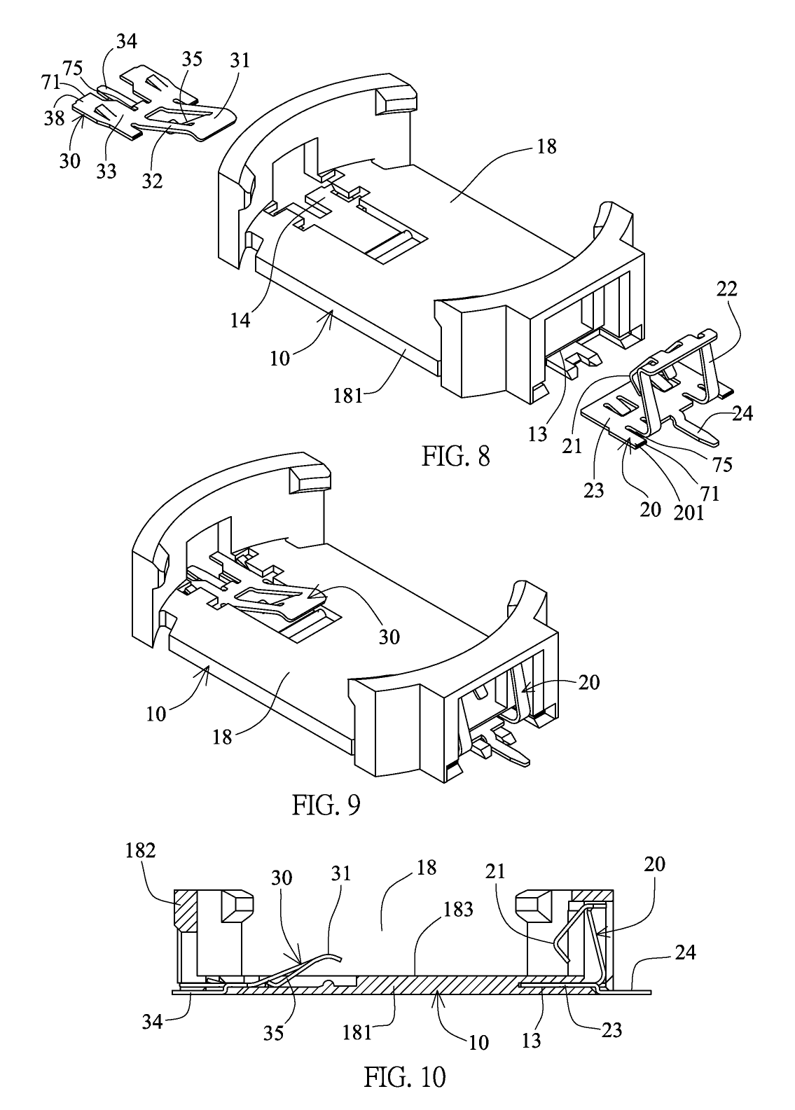

As shown in FIGS. 8 to 10, the third embodiment of the invention relates to a battery holder of a notebook computer, which is substantially the same as the second embodiment except for the following differences. The pins 24 and 34 of the positive and negative terminals 20 and 30 have the horizontal end sections. The bottom portion 181 of the accommodating slot is thinner. The second embodiment is applicable to a desktop computer.

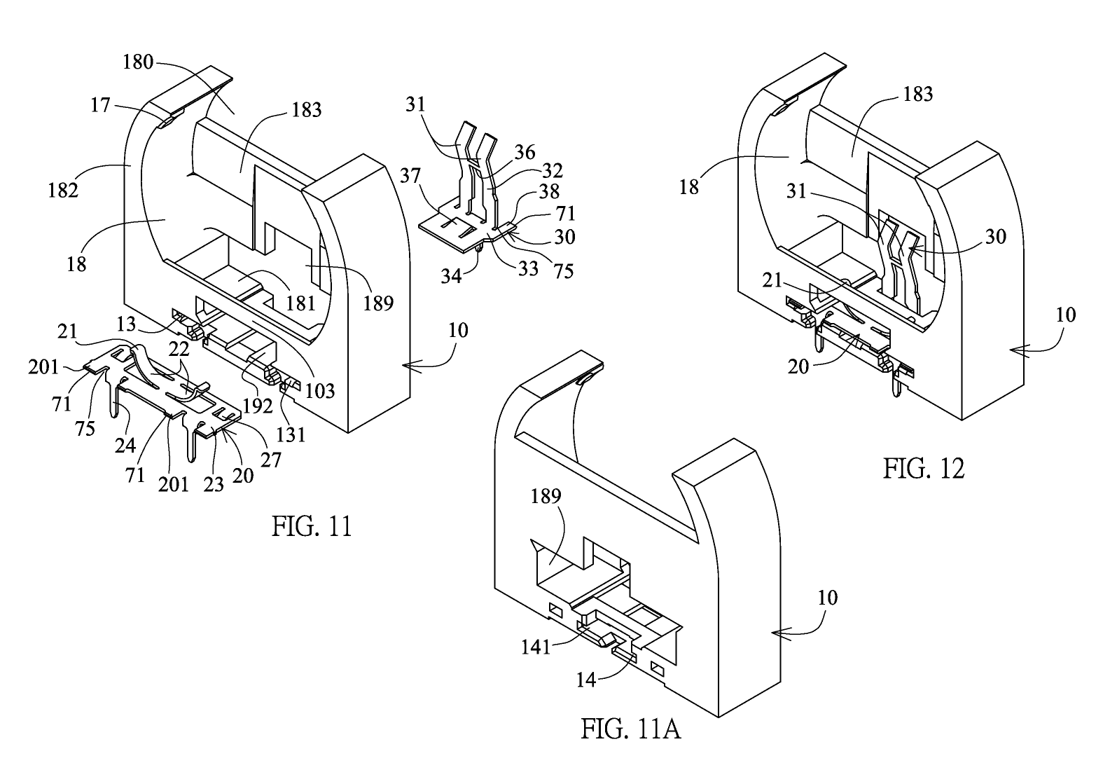

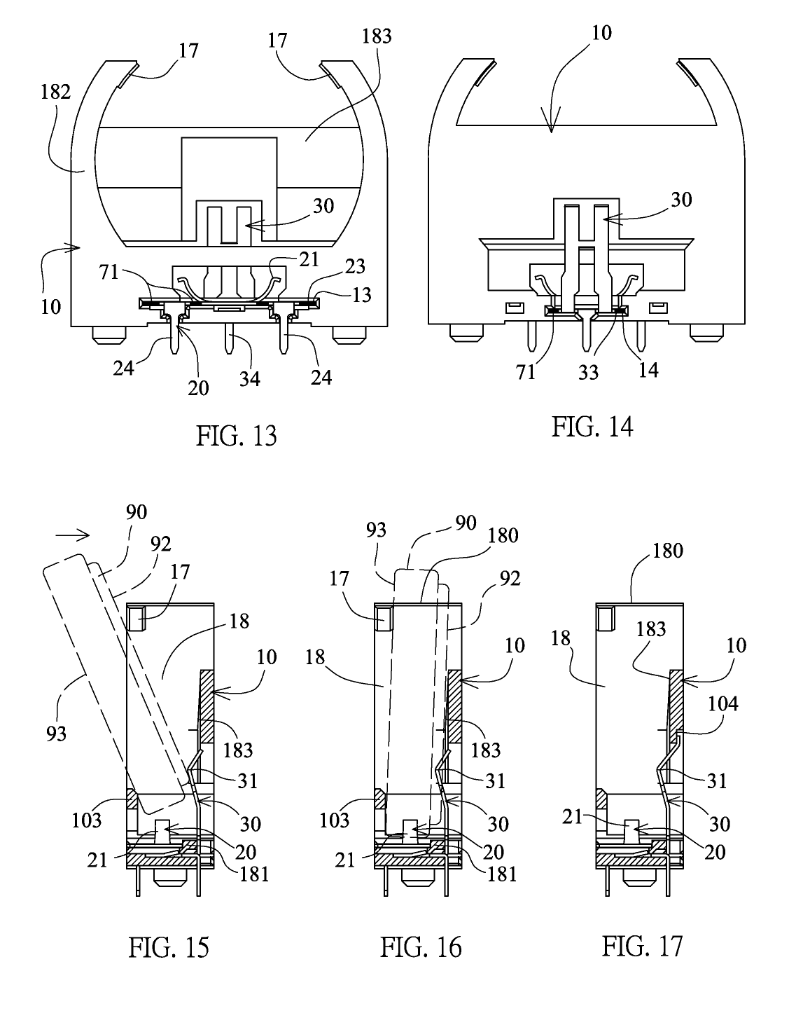

Referring to FIGS. 11 to 16, a vertical battery holder according to the fourth embodiment of the invention includes a plastic base 10, a positive terminal 20 and a negative terminal 30.

The plastic base 10 has a positive terminal fixing slot 13, a negative terminal fixing slot 14 and an accommodating slot 18. The accommodating slot 18 has a bottom portion 181, a receiving surface 183 and a circumferential wall 182. The circumferential wall 182 is connected to the left and right sides of the bottom portion 181 and extends upward. The receiving surface 183 is connected to the rear end of the circumferential wall 182, extends vertically and is slightly inclined backwards, so that the accommodating slot 18 is vertical and has an open front end. The receiving surface 183 is for receiving a negative surface 92 of a battery 90. The top end of the circumferential wall 182 has a notch 180, into which the finger can be inserted to take the battery. Each of the inner edges of front ends of two sides of the circumferential wall 182 close to the notch 180 has an engaging block 17. The front and rear ends of the engaging block 17 have an inclined guide-in surface and an inclined guide-out surface, and two sides of the circumferential walls, on which the engaging blocks 17 are disposed, are not connected to the receiving surface 183 to possess the elasticity of elastically moving outwards. The front end of the bottom portion 181 integrally has a stopping plate 103 having the height smaller than one-half of the height of the accommodating slot 18, so that the front end of the accommodating slot is at least half-opened. The stopping plate 103 only has the height substantially equal to one-fourth of the height of the accommodating slot 18. The battery can be slantingly inserted and then pressed for positioning from the front end of the accommodating slot. The top and bottom sides of the positive surface of the battery are engaged with the engaging block and the stopping plate, respectively. The stopping plate 103 has an opening 192. The receiving surface 183 has a T-shaped opening 189. The front-to-rear direction of the stopping plate 103 corresponds to the opening 189, so that the receiving surface 183 and the stopping plate 103 are staggered in the front-to-rear direction without the opposite surfaces in the front-to-rear direction. Thus, the plastic base 10 can be formed by way of injection molding and combining molds in the front-to-rear direction. The positive and negative terminal fixing slots 13 and 14 are disposed on the bottom portion 181 and extend horizontally in the front-to-rear direction. The positive terminal fixing slot 13 has an inserting port 131 on the front end of the bottom portion 181. The negative terminal fixing slot 14 has an inserting port 141 on the rear end of the bottom portion 181.

The positive terminal 20 integrally has a fixing portion 23, two elastic arms 22 and two pins 23. The fixing portion 24 is horizontal and is assembled with and fixed to the positive terminal fixing slot 13 from the inserting port 131. Each of the two elastic arms 22 is connected to the fixing portion 23 and elastically vertically movable, and has a contact 21 projecting upwards beyond the bottom portion 181 to the accommodating slot 18. The two elastic arms 22 are prodded and project from the plate surface of the fixing portion 23 and are left-to-right symmetrically bent and extend upward. The contact 21 runs to the accommodating slot 18 through the opening 192 of the stopping plate 103. The pin 24 is connected to the outer end of the fixing portion 23 and bent downwards and has the end section vertical extending out of the plastic base 10. The plate surface of the fixing portion 23 is prodded to form a projecting inverse hook 27 capable of engaging with the bottom portion 181 of the plastic base 10. One end of the fixing portion 23 connected to the pin 24 is formed with a connection projection 201 on each of two sides of the pin 24. The distal end of the connection projection 201 has a plateless cut surface 71, and a pressing gap 75 is formed between the distal end of the connection projection 201 and the pin 24.

The negative terminal 30 integrally has a fixing portion 33, an elastic arm 32 and a pin 34. The fixing portion is horizontal and is assembled and fixed to the negative terminal fixing slot 14 from the inserting port 141. The plate surface of the elastic arm 32 is pressed to form two force arms connected to a connection sheet 36. The elastic arm 32 is elastically movable in a front-to-rear direction and has a projecting contact 31. The contact 31 runs to the accommodating slot 18 through the opening 189 of the receiving surface 183. The pin 34 is formed by pressing and bending the plate surface of the elastic arm 32, is connected to the outer end of the fixing portion 33 and bent downwards, and has the end section vertical extending out of the plastic base 10. The plate surface of the fixing portion 33 is prodded to form a projecting inverse hook 37 capable of engaging with the bottom portion 181 of the plastic base 10. One end of the fixing portion 33 connected to the pin 34 has a connection projection 38 on each of two sides of the pin 34 and the elastic arm 32. The distal end of the connection projection 38 has a plateless cut surface 71, and a pressing gap 75 is formed between the distal end of the connection projection 38 and the elastic arm 32.

The width of the inserting port 131 of the positive terminal fixing slot 13 is larger than that of the fixing portion 23 of the positive terminal 20 or that of the inserting end of the fixing portion 23. The width of the inserting port 141 of the negative terminal fixing slot 14 is larger than that of the fixing portion 23 of the negative terminal 30 or that of the inserting end of the fixing portion 23.

With the above-mentioned structure, as shown in FIG. 15, the battery 90 is vertically and slantingly inserted into the accommodating slot 18, and a side edge of the positive surface 93 of the battery 90 is firstly engaged by the stopping plate 103. After being pressed backwards, the other side edge of the positive surface of the battery 90 runs over the engaging block 17 and is engaged thereby. The negative surface 92 of the battery 90 is received by the receiving surface 183, as shown in FIG. 16. When the battery 90 is to be taken out, the finger is inserted from the notch 180 to pull the battery frontwards so that the battery can be taken out.

As shown in FIG. 17, the fifth embodiment of the invention is substantially the same as the fourth embodiment except for the following differences. The backside of the receiving surface 183 has a depressed position restricting surface 104. The distal end 39 of the elastic arm of the negative terminal 30 rests against the position restricting surface 104 so that the contact 31 of the negative terminal 30 has the excess pressure and projects toward the accommodating slot 18 and the more definitive electrical connection effect can be obtained.

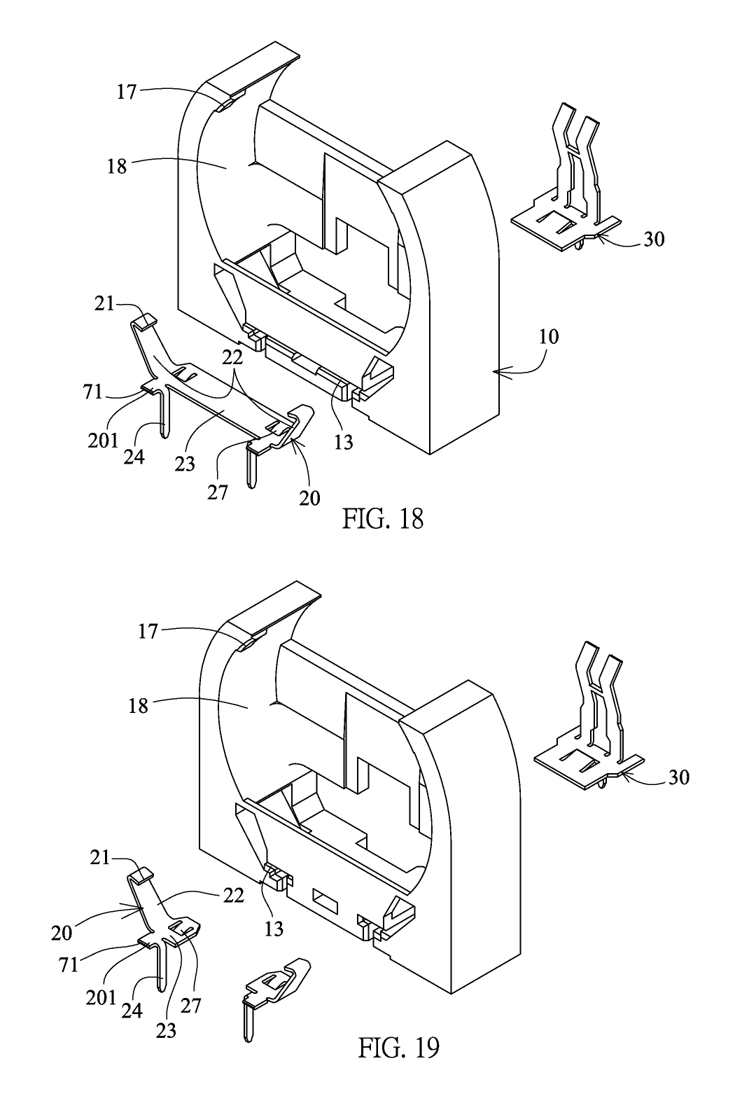

As shown in FIG. 18, the sixth embodiment of the invention is substantially the same as the fourth embodiment except for the following differences. The two pins 24 of the positive terminal 20 are torn off from the plate surface of the outer end of the fixing portion 23 and extend vertically downwards. In addition, the contact 21 is formed by reversely bending the end section of the elastic arm 22.

As shown in FIG. 19, the seventh embodiment of the invention is substantially the same as the sixth embodiment except for the following differences. Two positive terminals 20 are provided. The positive terminal 20 has an elastic arm 22, a fixing portion 23 and a pin 24. The plastic base 10 has two horizontal positive terminal fixing slots 13, into which the two fixing portions 23 of the positive terminals 20 are horizontally assembled and engaged.

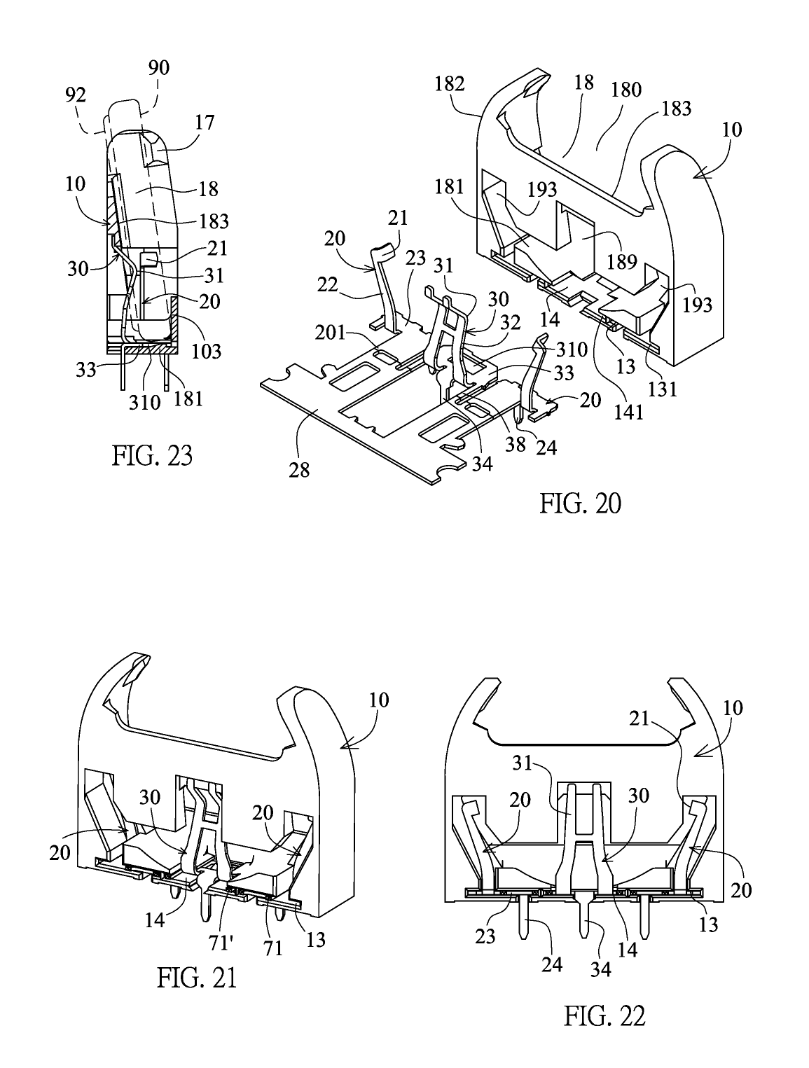

As shown in FIGS. 20 to 23, the eighth embodiment of the invention is substantially the same as the fourth embodiment except for the following differences. Two positive terminal fixing slots 13 are disposed, in parallel, on left and right sides of the negative terminal fixing slot 14, respectively. The positive and negative terminal fixing slots 13 and 14 are disposed at the same level and extend in the same horizontal direction. The inserting ports 131 of the two positive terminal fixing slots 13 and the inserting port 141 of the negative terminal fixing slot 14 are disposed on the rear end of the bottom portion 181. In addition, each of left and right sides of the T-shaped opening 189 of the receiving surface 183 has an opening 193. The receiving surface 183 tilts backward much more by about 10 degrees.

The negative terminal 30 and the two positive terminals 20 are formed by pressing the same metal sheet. The outer end of the fixing portion 33 of the negative terminal 30 and the outer ends of the fixing portions 23 of the two positive terminals 20 are formed with connection projections 38 and 201, respectively, connected to a material tape 28. The fixing portion 33 of the negative terminal and the fixing portions 23 of the positive terminals 20 are disposed at the same level, are assembled into and engaged with the positive and negative terminal fixing slots 13 and 14 from the inserting ports 141 and 131 horizontally at a time, and then the material tape 28 is broken. The outer end of the connection projection 38 of the fixing portion 33 of the negative terminal 30 forms the plateless cut surface 71′. The outer ends of the connection projections 201 of the two fixing portions 23 of the positive terminals 20 form the plateless cut surface 71. The plateless cut surfaces 71′ and 71 are disposed at the same level and are flush with each other in the front-to-rear direction. The fixing portions 23 and 33 of the positive and negative terminals 20 and 30 have the same height. The contacts 21 of the two positive terminals 20 run to the accommodating slot 18 through the two openings 193. The contact 31 of the negative terminal 30 runs to the accommodating slot 18 through the opening 189.

The elastic arm 22 of the positive terminal 20 is connected to the outer end of the fixing portion 23 and is bent and extends upward. The contacts 21 are connected to the top ends of the elastic arms 22 and are turned by 90 degrees and run into left and right sides of the accommodating slot 18, respectively.

The fixing portion 33 of the negative terminal 30 has an opening region 310 so as to stagger with the positive pole of the lateral side of the battery 90, as shown in FIG. 23.

In this embodiment, the positive and negative terminals are formed by pressing the same metal sheet and are assembled with the plastic base at a time so that the convenience in manufacturing is obtained. However, in addition to the above-mentioned structure, the fixing portions of the positive and negative terminals may also be configured to be disposed on different levels, while the plateless cut surfaces thereof are disposed at the same level and are flush with each other in the front-to-rear direction.

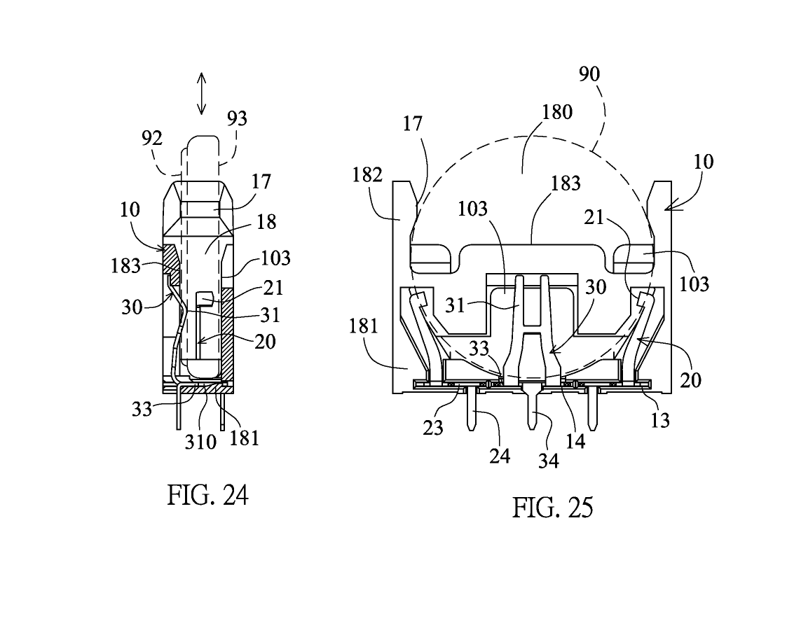

As shown in FIGS. 24 and 25, the ninth embodiment of the invention is substantially the same as the fourth embodiment except for the following differences. The two engaging blocks 17 are disposed on the inner edges of the top ends of two sides of the circumferential wall 182 so as to engage with the two lateral sides of the upper section of the battery 90. The top and bottom ends of the engaging block 17 have an inclined guide-in surface and an inclined guide-out surface. The height of the stopping plate 103 of the front end of the accommodating slot 18 is greater than one half of the height of the accommodating slot so as to receive the positive surface 93 of the battery 90. The height of the stopping plate is equal to about three-quarters of the height of the accommodating slot. The battery can be directly and vertically placed for positioning or taken out from the notch 180 of the top end of the accommodating slot.

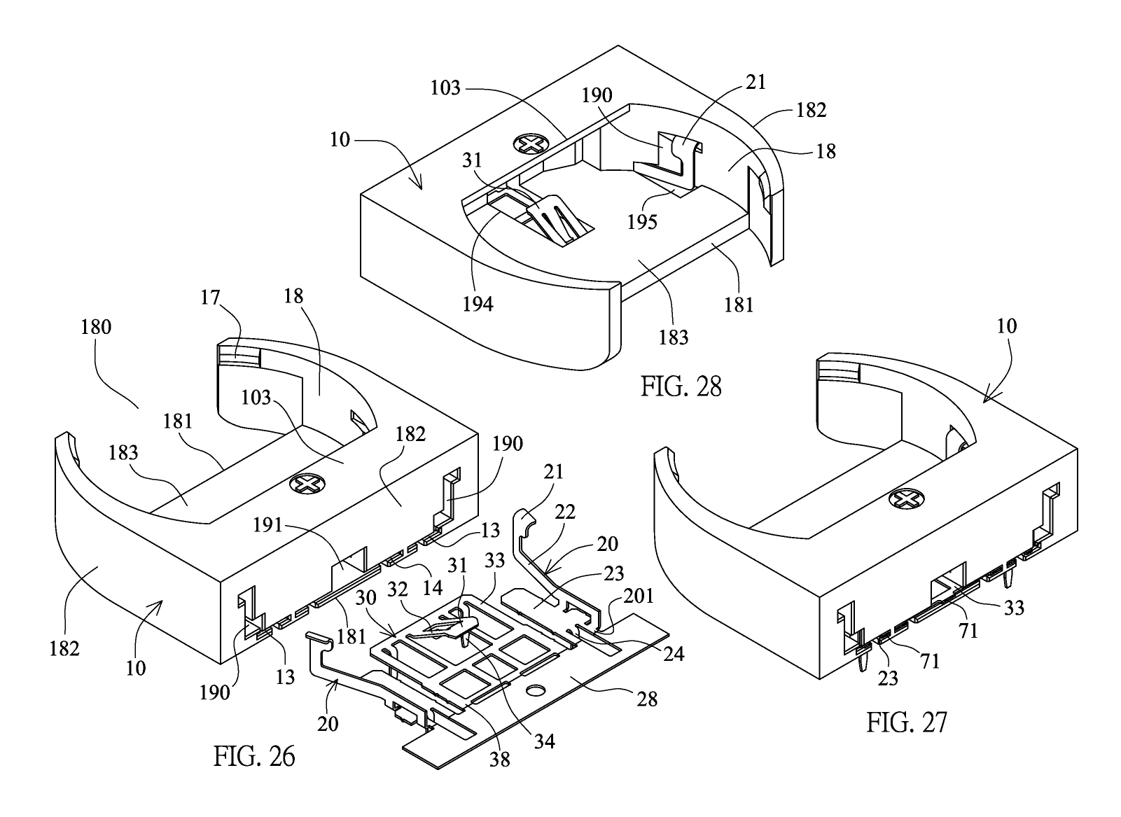

As shown in FIGS. 26 to 28, the tenth embodiment of the invention is substantially the same as the second and fourth embodiments except for the following differences. In this embodiment, the horizontal type is provided. However, the structure of this embodiment is substantially modified from the vertical type of the fourth embodiment to the horizontal type.

The plastic base 10 has an accommodating slot 18, two positive terminal fixing slots 13 and a negative terminal fixing slot 14. The accommodating slot 18 has a bottom portion 181 and a circumferential wall 182. The circumferential wall 182 surrounds the bottom portion 181. The front end of the circumferential wall 182 has a notch 180, into which the hand can go to take the battery. The top surface of the bottom portion 181 is a receiving surface 183 for receiving the negative surface of the battery. Each of the inner edges of the top ends of the two sides of the circumferential wall 182 close to the notch 180 has an engaging block 17. The top and bottom ends of the engaging block 17 have an inclined guide-in surface and an inclined guide-out surface. Two sides of the circumferential wall 182 formed with the engaging blocks 17 are not connected to the receiving surface 183 to possess the elasticity of elastically moving outwards. The rear top end of the circumferential wall 182 integrally has a stopping plate 103 projecting inwards. Similar to the fourth embodiment, the positive and negative terminal fixing slots 13 and 14 are disposed on the bottom portion 181, and the inserting ports are disposed on the rear end of the bottom portion 181. The rear end of the circumferential wall 182 has an opening 190 above the inserting port of each of the two positive terminal fixing slots 13, and has an opening 191 above the inserting port of the negative terminal fixing slot 14. The middle of the receiving surface 183 has a slot 194, and each of the left and right sides of the receiving surface 183 has a slot 195.

The manufacturing processes and the structures of the negative terminal 30 and the two positive terminals 20 are substantially the same as those of the fourth embodiment except for the difference that the negative terminal 30 has two pins 34. So, the battery holder of this embodiment has four pins so that the stabler positioning effect can be obtained. The elastic arm 22 of the positive terminal 20 is connected to one side of the fixing portion 23, so that the elastic arm 22 tends to move elastically and laterally. In addition, when the positive and negative terminals 20 and 30 are developed on the plane, the contacts 21 and 31 are on the same surface, and this is advantageous to the plating process.

The plateless cut surface 71 of the outer end of the connection projection 201 of the fixing portion 23 of the positive terminal 20 and the plateless cut surface 71′ of the outer end of the connection projection 38 of the fixing portion 33 of each of the two negative terminals 30 are disposed at the same level and are flush with each other in the front-to-rear direction. The fixing portions 23 and 33 of the positive and negative terminals 20 and 30 have the same height. The contacts 21 of the two positive terminals 20 run to the accommodating slot 18 through the two openings 190. The contact 31 of the negative terminal 30 runs to the accommodating slot 18 through the opening 191.

In use, the battery can be slantingly placed into the accommodating slot 18, so that one side of the positive surface is engaged with the stopping plate 103 and then pressed for positioning. Two sides of the positive surface of the battery are engaged with the engaging block 17 and the stopping plate 103, respectively.

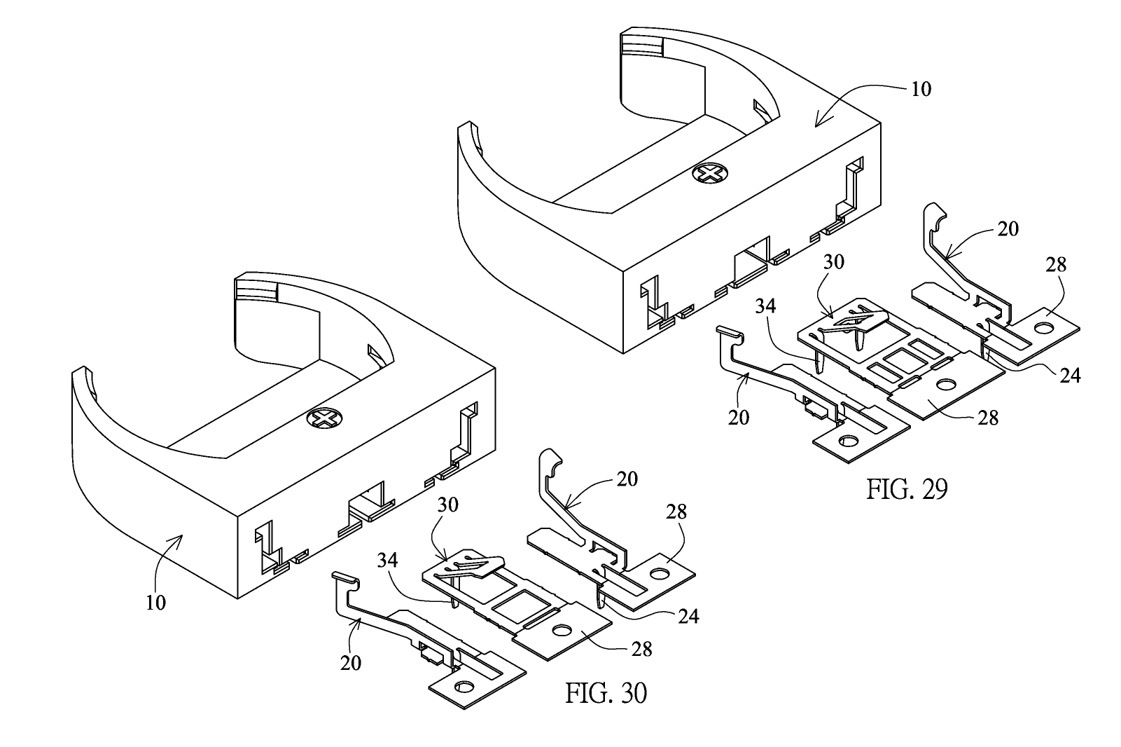

As shown in FIG. 29, the eleventh embodiment of the invention is substantially the same as the tenth embodiment except for the difference that the positive and negative terminals 20 and 30 are manufactured from different metal sheets.

As shown in FIG. 30, the twelfth embodiment of the invention is substantially the same as the eleventh embodiment except for the difference that the negative terminal 30 has only one pin 34.

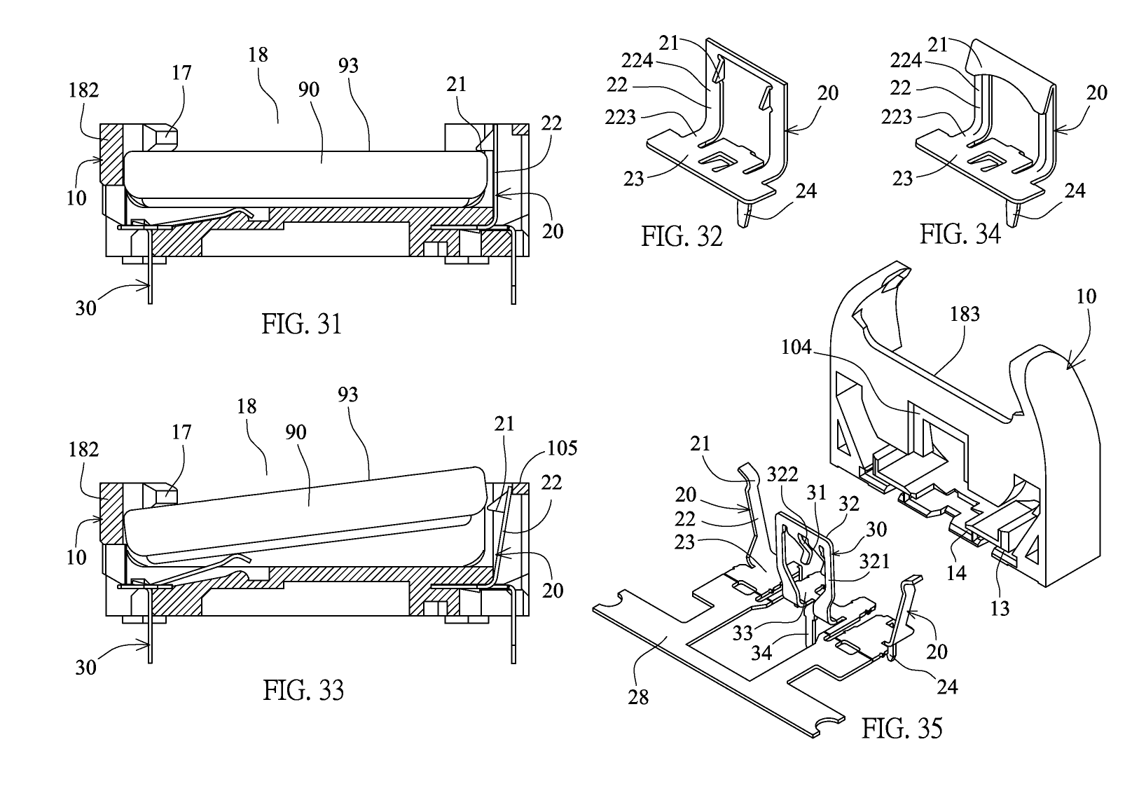

As shown in FIGS. 31 to 33, the thirteenth embodiment of the invention is substantially the same as the second embodiment except for the following differences. A vertical contact 21 in the form of two separate engaging blocks is provided near the distal end of the vertical force arm 224 of the elastic arm 22 of the positive terminal 20. The top end of the engaging block is an inclined guide-in surface, and the bottom end of the engaging block is an engaging surface for engaging with one side of the positive surface 93 of the battery 90. A hand can actuate the portion between the two engaging blocks.

As shown in FIG. 33, when the elastic arm 22 of the positive terminal 20 is actuated outwards to rest against the position restricting surface 105 of the circumferential wall, the battery 90 pops and can be taken out.

As shown in FIG. 34, the fourteenth embodiment of the invention is substantially the same as the thirteenth embodiment except for the difference that the end section of the elastic arm 22 of the positive terminal 20 of this embodiment is bend downwards to form the contact 21 capable of engaging with one side of the positive surface of the battery.

As shown in FIG. 35, the fifteenth embodiment of the invention is substantially the same as the eighth embodiment except for the following differences. The negative terminal 30 is formed by pressing the plate surface to form a first force arm 321 and a second force arm 322. The first force arm 321 is connected to the fixing portion 23 and extends upward. The second force arm 322 is connected to the first force arm 321 and extends downwards to form a projecting contact 31. The first force arm 321 can have the excess pressure and rests against the depressed position restricting surface 104 on the backside of the receiving surface 183. The second force arm 322 projects beyond the receiving surface 183. The elastic arm 22 of the positive terminal 20 is connected to one side of the fixing portion 23 so that the elastic arm 22 tends to move elastically and laterally. In addition, when the positive and negative terminals 20 and 30 are deployed on a plane, the contacts 21 and 31 are disposed on the same surface, and this is advantageous to the plating process.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A battery holder, comprising:
a plastic base having at least one positive terminal fixing slot, a negative terminal fixing slot and an accommodating slot, wherein the accommodating slot has a bottom portion and a circumferential wall, the circumferential wall is disposed around the bottom portion, a top surface of the bottom portion is a receiving surface for receiving a negative surface of a battery;
at least one positive terminal integrally having a fixing portion, an elastic arm and at least one pin, wherein the fixing portion is fixed to the positive terminal fixing slot, the elastic arm is connected to the fixing portion, extends upward and has a contact laterally projecting toward the accommodating slot, and the pin is connected to the fixing portion and extends out of the plastic base; and
a negative terminal integrally having a fixing portion, an elastic arm and at least one pin, wherein the fixing portion is fixed to the negative terminal fixing slot, the elastic arm is connected to the fixing portion, is elastically vertically movable and has a contact projecting upwardly toward the accommodating slot, and the pin is connected to the fixing portion and extends out of the plastic base, wherein:
the positive terminal fixing slot is disposed on the bottom portion, extends horizontally and has an inserting port located at one end of the bottom portion, the fixing portion of the positive terminal is horizontal and inserted from the inserting port and engages with the positive terminal fixing slot, the circumferential wall above the inserting port has an opening so that the contact of the positive terminal can run to the accommodating slot through the opening.

2. The battery holder according to claim 1, wherein the at least one positive terminal fixing slot contains only one positive terminal fixing slot, and the at least one positive terminal contains only one positive terminal.

3. The battery holder according to claim 1, wherein:
at least one side of the plastic base is cut off to decrease a width; or
two corresponding sides of the plastic base are cut off, the circumferential wall has two opposite walls, and the two opposite walls are connected to two opposite ends of the bottom portion, wherein an inner edge of a top end of one of the opposite walls close to the negative terminal has at least one projecting engaging block for engaging with one side of a positive surface of the battery.

4. The battery holder according to claim 1, wherein an inner edge of a top end of one end of the circumferential wall close to the negative terminal has at least one engaging block for engaging with one side of a positive surface of the battery.

5. The battery holder according to claim 4, wherein:
a lower edge of a circumferential wall corresponding to the at least one engaging block is separated from the bottom portion by a gap and to be staggered with a projecting position of the engaging block;
top and bottom ends of the at least one engaging block have inclined guiding surfaces;
the inner edge of the top end of one end of the circumferential wall close to the positive terminal also has at least one engaging block for engaging with the other side of the positive surface of the battery; or
the contact of the positive terminal may engage with the positive surface of the battery.

6. The battery holder according to claim 1, wherein:
a top end of the opening above the inserting port is closed to form a top surface;
the elastic arm of the positive terminal has a first force arm and a second force arm both extending vertically, wherein the first force arm extends from bottom to top, and the second force arm is connected to the first force arm and extends downwards to form the contact laterally projecting toward the accommodating slot; or
the elastic arm of the positive terminal rests against the circumferential wall.

7. The battery holder according to claim 1, wherein the negative terminal fixing slot is also disposed on the bottom portion, extends horizontally and has an inserting port disposed on one end of the bottom portion, the fixing portion of the negative terminal is horizontal and is inserted into and engages with the negative terminal fixing slot from the inserting port, and the circumferential wall above the inserting port has an opening, through which the contact of the negative terminal can run to the accommodating slot.

8. The battery holder according to claim 7, wherein the positive and negative terminal fixing slots extend in the same direction and have the same inserting port, a width of the fixing slot near the inserting port is greater than a width of the fixing slot away from the inserting port, and the opening of the circumferential wall above the inserting port allows the contacts of the positive and negative terminals to pass.

9. The battery holder according to claim 7, wherein the positive and negative terminal fixing slots extend reversely and have different inserting ports, the inserting ports of the positive and negative terminal fixing slots are disposed on two opposite ends of the bottom portion, the circumferential wall above each of the inserting ports has the opening, and the openings allow the contacts of the positive and negative terminals to pass.

10. The battery holder according to claim 7, wherein:
at least portions of a top surface and a bottom surface of the opening of the circumferential wall above the inserting port of the positive terminal fixing slot face each other;
at least portions of the top surface and the bottom surface of the positive terminal fixing slot face each other vertically; or
at least portions of the top surface and the bottom surface of the opening of the circumferential wall above the inserting port of the positive terminal fixing slot face each other vertically, and at least portions of the top surface and the bottom surface of the positive terminal fixing slot face each other vertically.

11. The battery holder according to claim 10, wherein the positive and negative terminal fixing slots extend reversely and have the inserting ports, respectively, the inserting ports of the positive and negative terminal fixing slots are disposed on two opposite ends of the bottom portion, the opening of the circumferential wall above the inserting port of the negative terminal fixing slot only has a top surface without a bottom surface, and the top surface and the bottom surface of the negative terminal fixing slot are vertically staggered.

12. The battery holder according to claim 1, wherein:
the elastic arm of the positive terminal has a horizontal force arm and a vertical force arm;
the elastic arm of the positive terminal has the horizontal force arm and the vertical force arm, and the plastic base has a slot providing an elastic moving space for the horizontal force arm; or
the fixing portions of the positive and negative terminals are horizontally and correspondingly assembled into the positive and negative terminal fixing slots, and one end of the fixing portion has at least one plateless cut surface.

13. The battery holder according to claim 7, wherein the positive and negative terminal fixing slots are disposed in a left-to-right direction, the positive and negative terminal fixing slots have different inserting ports disposed on the same end of the bottom portion, and each of outer ends of the fixing portions of the positive and negative terminals has at least one plateless cut surface.

14. A battery holder, comprising:
a plastic base having at least one positive terminal fixing slot, a negative terminal fixing slot and an accommodating slot, wherein the accommodating slot has a bottom portion, a receiving surface and a circumferential wall, the circumferential wall is connected to left and right sides of the bottom portion and extends upward, the receiving surface is connected to a rear end of the circumferential wall and extends vertically so that the accommodating slot is vertical, the receiving surface is for receiving a negative surface of a battery, and a top end of the circumferential wall has a notch into which a finger can be inserted to take the battery;
at least one positive terminal integrally having a fixing portion, at least one elastic arm and at least one pin, wherein the fixing portion is fixed to the positive terminal fixing slot, the elastic arm is connected to fixing portion, is elastically movable and has a contact projecting toward the accommodating slot, and the pin is connected to the fixing portion and extends out of the plastic base; and
a negative terminal integrally having a fixing portion, an elastic arm and at least one pin, wherein the fixing portion is fixed to the negative terminal fixing slot, the elastic arm is elastically movable in a front-to-rear direction and has a contact projecting beyond the receiving surface toward the accommodating slot, and the pin is connected to the fixing portion and extends out of the plastic base, wherein:
at least one of the positive and negative terminal fixing slots is disposed on the bottom portion, extends horizontally and has an inserting port located at one end of the bottom portion, wherein at least one of the fixing portions of the positive and negative terminals is horizontal and is inserted from the inserting port and engages with the positive and negative terminal fixing slots.

15. The battery holder according to claim 14, wherein:
each of the positive and negative terminal fixing slots is disposed on the bottom portion, extends horizontally and has the inserting port, the fixing portions of the positive and negative terminals are horizontally and correspondingly assembled into the positive and negative terminal fixing slots; or
the fixing portions of the positive and negative terminals are horizontally and correspondingly assembled into the positive and negative terminal fixing slots, and an outer end of the fixing portion has at least one plateless cut surface.

16. The battery holder according to claim 14, wherein:
each of inner edges of front ends of two sides of the circumferential wall close to the notch has an engaging block, a front end of the bottom portion has a stopping plate for engaging with the other side of a positive surface of the battery, a height of the stopping plate is smaller than one half of a height of the accommodating slot so that a front end of the accommodating slot is at least half-opened, the battery may be slantingly inserted and then pressed for positioning from the front end of the accommodating slot, and top and bottom sides of the positive surface of the battery are engaged with the engaging block and the stopping plate, respectively; or
each of inner edges of top ends of two sides of the circumferential wall has an engaging block for engaging with a lateral side of the battery, the front end of the accommodating slot has a stopping plate for receiving the positive surface of the battery, a height of the stopping plate is greater than one half of a height of the accommodating slot, the battery may be placed for positioning from top to bottom through the opening of a top end of the accommodating slot, and the two engaging blocks engage with two lateral sides of an upper section of the battery.

17. The battery holder according to claim 16, wherein:
the receiving surface and the stopping plate are staggered in the front-to-rear direction without facing each other in the front-to-rear direction;
the receiving surface or the stopping plate has an opening, through which the contact of the positive terminal or the contact of the negative terminal runs to the accommodating slot;
the receiving surface or the stopping plate has an opening, through which the contact of the positive terminal or the contact of the negative terminal runs to the accommodating slot, and the receiving surface and the stopping plate are staggered in the front-to-rear direction without facing each other in the front-to-rear direction; or
the engaging block has an inclined guide-in surface and an inclined guide-out surface.

18. The battery holder according to claim 15, wherein the positive and negative terminal fixing slots are disposed in a left-to-right direction and the inserting ports of the positive and negative terminal fixing slots are disposed on the same end of the bottom portion, and each of outer ends of the fixing portions of the positive and negative terminals has at least one plateless cut surface.

19. The battery holder according to claim 18, wherein the plastic base comprises two positive terminal fixing slots and two positive terminals, each of the two positive terminals has a pin, and the two positive terminal fixing slots are disposed on left and right sides of the negative terminal fixing slot.

20. The battery holder according to claim 18, wherein:
the plateless cut surfaces of the fixing portions of the positive and negative terminals are disposed at the same level;
the plateless cut surfaces of the fixing portions of the positive and negative terminals are flush with each other in the front-to-rear direction; or
the negative terminal and at least one positive terminal are formed by pressing the same metal sheet, an outer end of the fixing portion of the negative terminal and an outer end of the fixing portion of the at least one positive terminal are connected to a material tape, the fixing portion of the negative terminal and the fixing portion of the at least one positive terminal are horizontal, are one-time assembled into and engaged with the positive and negative terminal fixing slots, and then the material tape are broken so that the outer end of the fixing portion forms the plateless cut surface, and the plateless cut surfaces are disposed at the same level and flush with each other in the front-to-rear direction.
